(19) United States
(12) Patent Application Publication
(10) Pub. No.: US 2012/0267327 A1
(43) Pub. Date: Oct. 25, 2012

(54) WATER-ON-WATER FILTRATION SYSTEM WITH PRECISION METERING DEVICE

(76) Inventors: Andrew M. Candelora, East Haven, CT (US); Robert E. Astle, Middlefield, CT (US); Laurence W. Bassett, Killingworth, CT (US)

(21) Appl. No.: 13/517,363

(22) PCT Filed: Dec. 21, 2010
(86) PCT No.: PCT/US2010/061482

§ 371 Date: Jun. 20, 2012

Related U.S. Application Data
(60) Provisional application No. 61/290,694, filed on Dec. 29, 2009.

(51) Int. Cl. B01D 29/88; B01D 61/10; C02F 1/00; B01D 61/08

(52) U.S. Cl. 210/808; 210/257.1; 210/257.2; 210/254; 210/136

(57) ABSTRACT

A water-on-water filtration system is provided that includes a filter member (480), two water-on-water vessels, and a precision metering device. Each water-on-water vessel also includes a first and a second chamber as well as a first piston (412) defining a mixing portion and a driving portion of the first chamber and a second piston (422) defining a concentrate portion of the second chamber. The system includes a plurality of valves that are controlled to place the first vessel in a fill state in which the first vessel is being filled with filtered water and concentrate, and a service state in which the diluted concentrate is pushed through a product conduit to its end use. A method of delivering filtered water is also provided

### FIELD

The present disclosure generally relates to filtration systems and mechanisms that can add precise amounts of additives to these systems.

### BACKGROUND

Water filtration systems designed for residential and commercial use have become increasingly popular. The popularity arises from the need to remove unwanted substances from input water to make output water safer for consumption in various end uses. Two common water filtration systems include systems that discharge product water into an enclosed pressure vessel against back pressure created by an air cell within the vessel (air-on-water systems); and systems that discharge product water, in the absence of back pressure, into an enclosed pressure vessel and into a flexible water cell that can be compressed by a separate source of water to remove the product water from the vessel (water-on-water systems).

Air-on-water systems are subject to the back pressure of the air cells which, essentially, reduces the pressure differential across the filtering portion of the system (e.g., a reverse osmosis membrane), thereby reducing the quality and quantity of filtered product water made in a given time. Product water quality particularly suffers if the product water is frequently drawn off and replaced in small quantities, as typically occurs in household systems that include a single filtering portion and a single storage vessel. Moreover, as the air cell-propelled water is emptied from the storage vessel, the air cell gradually loses pressure and the dispensing flow rate of the product water declines. Most air cell systems include an automatic shut-off valve that stops feed water flow, and thus further production of slow flush waste water, when the storage tank is full and typically reaches 60%-70% of line pressure. This technique, while reducing waste, can result in reduced quantity and quality of the product water and its dispensing flow rate.

Water-on-water systems can address many of the shortcomings of air-on-water system. Water-on-water systems typically include a pressure vessel containing two water-filled compartments of approximately the same size. The physical separation between the compartments is movable or flexible so that water pressure in a first compartment influences the water pressure in the second compartment. Each compartment is accessed by different fluid sources so that one compartment can be filling while the other one is emptying. Thus, little or no pressure drop occurs across the compartments. Both compartments are pressurized, when product water is drawn out of the vessel. Both compartments are then depressurized when product water is filling one compartment and displacing water from the other compartment to drain.

The quality of drinking water can vary depending upon the source of the water. For example, in some areas water comes from wells and can contain significant amounts of salts—some of which can impart a taste or an odor to the water. In other areas, water can come from streams, rivers, lakes, or even oceans—in the case of desalination plants. To produce a consistent water product such as, for example, bottled water, typically the source water is filtered to remove unwanted elements that can include salts, bacteria, viruses, or other ingredients that make the water unpalatable. However, filtered water does not always appeal to customers due to its bland nature. There is a desire to filter water and then to add back ingredients that cause the water to have a palatable taste. There is also a desire to be able to produce a consistent water product regardless of the source water.

### SUMMARY

Water-on-water filtration systems have many advantages compared to more commonly utilized water-on-air systems. One advantage of a water-on-water design is improved flow rate at the point of dispensing filtered water. In some instances, water-on-water systems can produce 1.5 to 3 times or greater the flow of typical air-on-water systems. Water-on-water systems can also provide improved delivery pressure at the point of dispense, typically on average of at least 2 times that of water-on-air systems. Improved delivery pressure can also provide increased production as the flow of water into and out of the storage vessel can increase as compared to water-on-air systems. In general, water-on-water systems also have improved efficiency in that they produce less waste water (water to drain) for every unit of filtered water produced. Water-on-water systems do not require a source of compressed air, and thus can have smaller size and space requirements. These and other advantages of water-on-water systems make water-on-water systems an advantageous technical field for implementation of the inventive principles disclosed herein. An exemplary twin vessel water-on-water filtration system is disclosed, for example, in U.S. Pat. Publ. No. 2009/0200238 (Astle et al.).

Some other types of filtration systems have some of the same shortcomings as water-on-air systems. For example, tankless filtration systems utilize a large filtering member that has capacity to produce a relatively large amount of filtered water. Large filtering members can be costly and require significant space. Also, in order to maximize production of filtered water, the pressure drop across the filtering member must be increased, resulting in a low output pressure on the delivery side of the tankless water-on-water system.

The use of a water-on-water filtration system that can include a reverse osmosis filter in combination with a precision metering system can be used to produce filtered drinking water that has consistent quality and taste. The provided water-on-water filtration system that includes a precision metering device can filter source water and then add back ingredients, which can be present in very minute amounts, to produce a consistent product regardless of the source water.

In one aspect a filtration system is provided that includes at least one water filtration member, a first water-on-water vessel in fluid communication with the filtration member and configured to alternate between a service state and a fill state, and a second water-on-water vessel in fluid communication with the filtration member and configured to alternate between a service state and a fill state, wherein the first water-on-water vessel, the second water-on-water vessel, or both comprise a device that includes a first chamber having a fixed volume and a second chamber having a fixed volume, each chamber having at least one outer wall, a first piston, disposed in the first chamber so that edges of the first piston slideably contact the outer wall of the first chamber forming a seal that divides the first chamber into a mixing portion and a driving portion, and a second piston, disposed in the second chamber so that edges of the second piston slideably contact the outer wall of the second chamber forming a seal that defines a concentrate portion concentrate portion in the second chamber, wherein the first piston and the second piston are in mechanical communication with each other so that when the first piston is displaced in the first chamber, the second piston is displaced in the second chamber, and wherein, when in the fill state, the concentrate portion of the second chamber is in fluid communication with the mixing portion of the first chamber.

In another aspect, a method of delivering filtered water with a water filtration system, is provided, the water filtration system including at least one filtering member, first and second water-on-water storage vessels, at least one concentrate source, and a control system, the first and second storage vessels each being configured to alternate between a fill state wherein the storage vessel is filled with filtered water and a service state wherein filtered water is expelled from the storage vessel, the method comprising generating a supply of filtered water with the filtering member, adding concentrate from at least one concentrate source to the first storage vessel using a dosing device, and adding concentrate from at least one concentrate source to the second storage vessel using a precision metering device, wherein the precision metering device includes a first chamber having a fixed volume and a second chamber having a fixed volume, each chamber having at least one outer wall, a first piston, disposed in the first chamber so that edges of the first piston slideably contact the outer wall of the first chamber forming a seal that divides the first chamber into a mixing portion and a driving portion, and a second piston, disposed in the second chamber so that edges of the second piston slideably contact the outer wall of the second chamber forming a seal that defines a concentrate portion concentrate portion in the second chamber, wherein the first piston and the second piston are in mechanical communication with each other so that when the first piston is displaced in the first chamber, the second piston is displaced in the second chamber, and wherein the concentrate portion of the second chamber is in fluid communication with the mixing portion of the first chamber.

In this disclosure:

“axially aligned” refers to two or more parts that share an axis of symmetry or parallel axes of symmetry;

“bladder” refers to a container that is deformable;

“conduit” refers to a fluid passageway;

“fluid” refers to liquid or gas;

“fluid communication” refers to the situation where two devices or parts of a device transfer fluid directly between each other; it is understood that other flow control devices may be included in the fluid communication system;

“linkage” refers to a system of elements used to transfer motion—the linkage can be a direct mechanical linkage or can be an indirect linkage through an energy-transferring medium that is later converted into mechanical motion such as, for example, an electrical signal to a solenoid valve;

“mechanical communication” refers to two or more parts that have a linkage;

“proportional manner” refers to a predetermined fixed ratio but can also be construed to mean in a ratio that varies in a predictable manner; and

“solvent” refers to any solution containing water to which concentrate is added whether pure solvent or solution.

The ability to provide a constant or a near constant flow of filtered water is important for many applications such as in the food service industry. The provided filtration system includes two vessels that alternatively take water from a filtration member (e.g., a reverse osmosis filter). Using two vessels, the provided filtration system can operate at maximum capacity at a relatively constant rate. Thus, the size and related space requirements for the filter member of the examples disclosed herein can be significantly smaller as compared to other filtration systems that have the same or similar output capability. Further, the use of alternating vessels wherein one vessel is in a fill state while the other is in a service state can function with two tanks that have smaller space requirements, even when combined, than filtration systems with similar output capability. Thus, the overall size and related space requirements for a filtration system of a given output capability can be smaller than comparable single storage vessel filtration systems when implementing the features disclosed herein. A still further effect of using a dual storage vessel water-on-water system is the reduction of total dissolved solids (TDS) creep in the system because of the near constant flow of water across the filtering member and the relatively high pressure differential across the filtering member.

The provided device and method can allow precise metering of small amounts of concentrate using mechanical linkages and can provide a precise amount of diluted solution at all times independent of the amount of solution that is needed. The provided device and method can be useful, for example, for adding catalysts to chemical reactions, adding antioxidants, heat and light stabilizers, dye solutions, or other liquid additives to product mixtures. Additionally the provided devices and methods can be useful for injecting precise amounts of additives to drinking water.

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

FIG. 1 is a schematic drawing of an embodiment of a filtration system that includes a provided precision metering device.

FIG. 2 is a schematic drawing of embodiment of a filtration system that includes a different embodiment of a provided precision metering device.

FIG. 3 is a schematic drawing of yet another embodiment of a provided precision metering device that includes two concentrate sources.

FIG. 4A is a schematic drawing of an embodiment of a provided filtration system where the first vessel is in a fill state and the second vessel is in a service state.

FIG. 4B is a schematic drawing of the same embodiment as illustrated in FIG. 4A except the first vessel is in a service state and the second vessel is in a service state.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

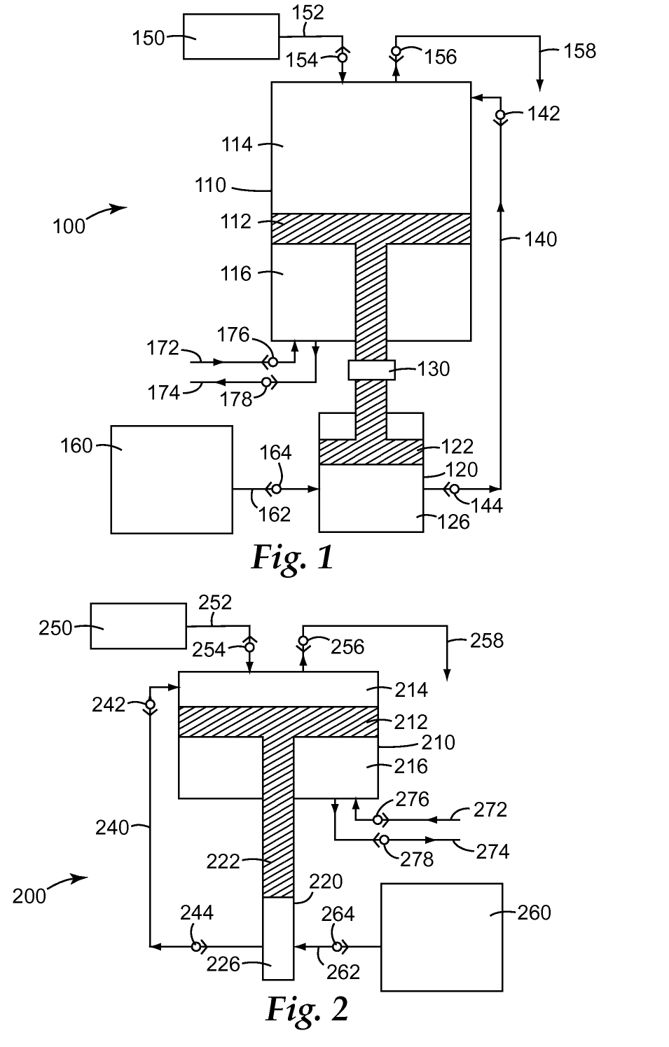

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range. A filtration system and method of delivering filtered water are provided that include a precision metering device. The provided filtration system and method are discussed later in this disclosure. Useful precision metering devices are described below and are also disclosed in, for example, Applicants' copending application, U.S. Provisional Application No. 61/290,699, filed Dec. 29, 2009. One embodiment of the provided device is shown in FIG. 1. Device 100 includes a first chamber 110, second chamber 120, first piston 112, second piston 122, linkage 130 and concentrate conduit 140. In the provided devices, the first chamber typically has a fixed volume that is greater than the fixed volume of the second chamber. First chamber 110 is divided into two portions—mixing portion 114 (the volume above first piston 112) and driving portion 116 (the volume below first piston 112). The volumes of mixing portion 114 and driving portion 116 vary as a function of the position of first piston 112 in first chamber 110. For example, when first piston 112 is completely extended (in its uppermost position as viewed in FIG. 1), the volume of mixing portion 114 is at its minimum and, consequently, the volume of driving portion 116 is at its maximum. Second piston 122 defines concentrate portion 126.

The first chamber can be axially aligned with the second chamber. For example, the first chamber can be directly aligned with the second chamber through a common axis. Alternatively the second chamber can be aligned on a separate axis wherein the separate axis is parallel to the first axis. Alternatively, the second chamber can have an axis that is at an angle to the axis to which the first chamber is aligned. For example, a screw gear can be used that can allow the second chamber to be at substantially right angles to the first chamber. Any other angles can also be accommodated by proper coupling.

It is not necessary that the first chamber or the second chamber to have rotational symmetry. For example, the linkage between the first piston and the second piston can be offset from center of one or the other pistons.

Linkage 130 can be any system that allows the transfer of mechanical motion between first piston 112 and second piston 122. In FIG. 1 the linkage is represented by 130 which is a generalized linkage element. Linkage 130 can be, for example, a solid rod that is mechanically connected to or in some embodiments is a rod element that has first piston 112 and second piston 122 at each end of the rod element. Thus, in one embodiment, first piston 112, linkage 130 (rod element), and second piston 122 are all one part. In other embodiments, linkage 130 can be, for example, a connecting rod, a radial linkage, an axial linkage, a shift linkage a clutch linkage, a rotary linkage, a peristaltic linkage, a spring or spring system, a gear or gear system, a hydraulic system, an electrical system such as a system comprising linear or non-linear motors, a telescoping system, or other systems that can transfer mechanical motion from first piston 112 to second piston 122 in a proportional manner

First chamber 110 and second chamber 120 can be in the shape of any volume element that can contain a fluid. For example, first chamber 110, second chamber 120 or both can be cylindrical. However, other shapes of volume elements for first chamber 110 and second chamber 120 are also contemplated. For example, first chamber 110, second chamber 120 or both can be rhomboid in shape having a cross-section of any type of polygon from a triangle to a multi-sided polygon. First piston 112 is disposed in first chamber 110 so that the edges of first piston 112 contact the complete outer wall of first chamber 110 and form a seal that divides first chamber 110 into the two portions described above. Analogously, second piston 122 is disposed in second chamber 120 so that the edges of second piston 122 contact the complete outer wall of second chamber 120 and form a seal that defines a concentrate portion. In both chambers, the seal is meant to prevent fluid from substantially traversing from one portion of the chamber to the other portion of the chamber. The first chamber can comprise a plurality of openings that can access the first chamber and the second chamber can comprise a plurality of openings that can access the second chamber. These openings typically are connected to conduits.

In the embodied device, concentrate portion 126 of second chamber 120 is in fluid communication with the mixing portion 114 of first chamber 110. In FIG. 1 fluid communication is through concentrate conduit 140. Concentrate conduit 140 can be a tube, a pipe, a channel, a hose, a passageway, a duct, a tunnel, a trough, or any combination of parts that allow fluid to flow from concentrate portion 126 of second chamber 120 into the mixing portion 114 of first chamber 110. Concentrate conduit 140 may include other items such as filters, meters, restrictors, pressure transducers, one-way checkvalves, or any other items that can modify the speed, pressure, and direction of flow of fluid from second chamber 120 to first chamber 110. Optional one-way checkvalves are shown in FIG. 1 for illustrative purposes only. One-way checkvalve 144 prevents the backflow of concentrate after it has been pushed out of concentrate portion 120 by an extension of second piston 122. One-way checkvalve 142 prevents backflow of concentrate during extension of first piston 112. Concentrate portion 126 of second chamber 120 is also in fluid communication with concentrate source 160 through concentrate source conduit 162 that includes one-way checkvalve 164.

A method of adding concentrate to a solvent such as filtered or unfiltered water can be best illustrated again by referring to FIG. 1. Although FIG. 1 is illustrated in a vertical orientation, this is not to be limiting but only used herein to discuss the provided method. Solvent source 150 is provided that is in fluid communication with mixing portion 114 of first chamber 110 via solvent conduit 152. Similarly, concentrate source 160 is provided that is in fluid communication with concentrate portion 126 of second chamber 120 via concentrate conduit 162. Concentrate source 160 can be a container that has concentrate. The container can be, for example, a tank, bottle, box, or bladder. In the illustrated embodiment of FIG. 1, a one-way checkvalve 154 is provided in solvent conduit 152 to prevent back flow of solvent and one-way checkvalve 164 is provided in concentrate conduit 162 to prevent backflow of concentrate.

First piston 112 is urged so as to increase the volume of mixing portion 114 of first chamber 110 (downward in FIG. 1 as oriented). This motion of first piston 112 draws solvent into mixing portion 114 from solvent source 150 through conduit 152 and one-way checkvalve 154. At the same time, second piston 122 moves in proportion to the motion of first piston 112 so as to decrease the volume in concentrate portion 126 of second chamber 120 forcing concentrate through one-way checkvalve 144, into concentrate conduit 140, through one-way checkvalve 142, and into mixing portion 114 of first chamber 110. Thus, metered amounts of concentrate and solvent fill mixing portion 114 at the same time and mixing portion 114 has the same concentration of concentrate and solvent regardless of its volume. Mixing can occur statically or with the additional mixing elements that may be present and in communication with mixing portion 114. During this urging of first piston 112, in the illustrated embodiment of FIG. 1, one-way checkvalves 142, 144, and 154 are in an open position allowing flow in the direction indicated by the arrows and one-way checkvalves 156 and 164 are in a closed position resisting flow in the direction indicated by the arrows.

After mixing portion 114 has reached its maximum volume (which can be any volume determined by the length of the stroke of first piston 112), one-way checkvalves 142, 144, and 154 are closed and one-way checkvalves 156 and 164 are opened. The one-way checkvalves can change state passively by just responding to the flow direction or they can be manipulated hydraulically or electronically by an external control system. First piston 112 is then urged so as to decrease the volume of mixing portion 114 (upward in FIG. 1). This motion forces the mixture of solvent and concentrate through one-way checkvalve 156 and through solvent/concentrate mixture conduit 158 to the end use or a storage container (not shown). At the same time, second piston 122 is proportionally moved so as to increase the volume of the concentrate portion 126 of second chamber 120. This motion allow concentrate to flow from concentrate source 160 through concentrate conduit 162 and one-way checkvalve 164 to replenish the concentrate in concentrate portion 126.

Optional fluid input conduit 172 with one-way checkvalve 176 and fluid output conduit 174 with one-way checkvalve 178 are illustrated as a part of FIG. 1. Input conduit 172 provides a way to introduce fluid into driving portion 116 of first chamber 110. Useful fluids can include liquids or gases. The fluid can provide hydraulic lifting of first piston 112. The fluid can be any substantially noncompressible liquid and can be forced into driving portion 116 by a pump. When first piston 112 is urged in the opposite direction, fluid can exit driving portion 116 through output conduit 174 and can be returned, for example, to a reservoir.

FIG. 2 is an illustration of an embodiment of a precision metering device that is useful in a provided filtration system. Device 200 includes a first chamber 210, second chamber 220, first piston 212, second piston 222, and concentrate conduit 240. First chamber 210 is divided into two portions—mixing portion 214 (the volume above first piston 212) and driving portion 216 (the volume below first piston 212). The volumes of mixing portion 214 and driving portion 216 vary as a function of the position of first piston 212 in first chamber 210 in the same manner as describe above for the embodiment illustrated in FIG. 1. In the embodiment shown in FIG. 2, first piston 212 and second piston 222 have a solid rod as a linkage between them. First piston 212 and second piston 222 are actually one piece. First piston 212 and second piston 222 are axially aligned so that when first piston 212 is urged in a manner so as to increase the volume of mixing portion 214, second piston 222 moves an equal distance along the common axis and decreases the volume in concentrate portion 226.

FIG. 2 also shows solvent source, typically water or filtered water, 250 in fluid communication with mixing portion 214 of first chamber 210 through solvent conduit 252 (containing one-way checkvalve 254), concentrate source 260 in fluid communication with concentrate portion 226 of second chamber 220 through conduit 262 (containing one-way checkvalve 264), solvent/concentrate mixture conduit 258 (containing one-way checkvalve 256), one-way checkvalves 242 and 244 to control flow of concentrate through concentrate conduit 240, and optional fluid input conduit 272 with one-way checkvalve 276 and fluid output conduit 274 with one-way checkvalve 278.

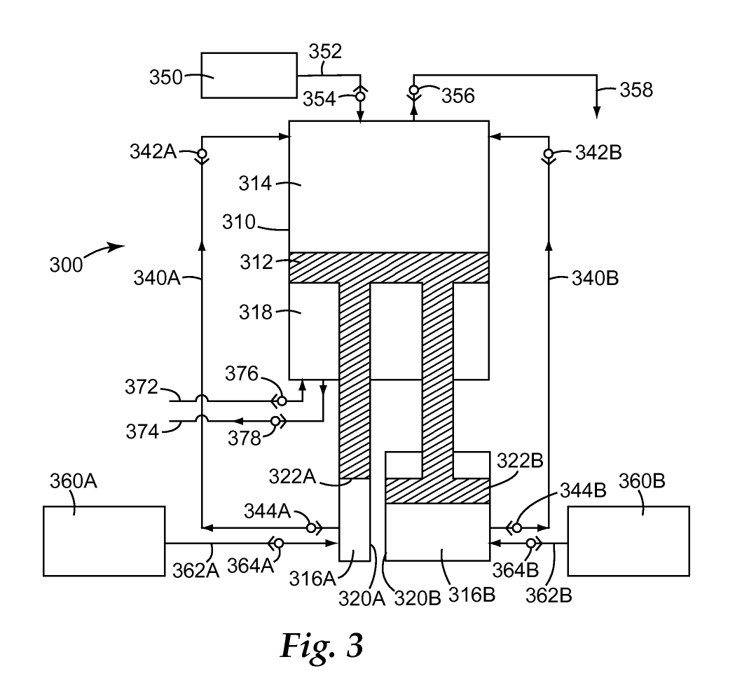

FIG. 3 illustrates another embodiment of a provided device. FIG. 3 illustrates device 300 that includes first chamber 310, second chamber 320A, and third chamber 320B. Solvent source 350 is in fluid communication with mixing portion 314 of first chamber 310 through solvent conduit 352 and one-way checkvalve 354. First concentrate source 360A is in fluid communication with concentrate portion 316A of second chamber 320A via concentrate conduit 362A and one-way checkvalve 364A and second concentrate source 360B is in fluid communication with concentration portion 316B of third chamber 320B via concentrate conduit 362B and checkvalve 364B. Additionally, concentrate portion 316A is in fluid communication with mixing portion 314 of first chamber 310 through fluid conduit 340A that includes one-way checkvalves 342A and 344A and concentrate portion 316B is in fluid communication with mixing portion 314 of first chamber 310 through fluid conduit 340B that includes one-way checkvalves 342B and 344B. First piston 312 separates first chamber 310 into mixing portion 314 and driving portion 318. Driving portion 318 is in fluid communication with fluid input conduit 372, which includes one-way checkvalve 376, and fluid output conduit 374, which includes one-way checkvalve 378. First piston 312 is in mechanical communication with both second piston 322A and third piston 322B. Second chamber 320A can be different in size, volume, and shape from third chamber 320B. Similarly, second piston 322A can be different in size, and shape from third piston 322B. Mixing portion 314 of first chamber 310 also is in fluid communication with solvent/mixture conduit 358 (containing one-way checkvalve 356). Although not illustrated in FIG. 3, it is contemplated that second piston and third piston, each, independently can have a different type of linkage to first piston 312.

A water-on-water filtration system is provided that includes twin vessels, each including a precision metering device. The provided filtration system utilizes potential energy in the form of feed pressure for water delivery. Typical water filtration systems utilize compressed air. The provided filtration system can include two alternating vessels. One of the vessels can be in fill mode (also referred to as a fill state) while the other vessel can be in a delivery mode (also referred to as a service state). This type of alternating vessel system can provide the ability to make and mix additives into filtered water while the system is concurrently dispensing product.

The provided filtration system includes at least one water filtration member. The provided filtration systems can utilize any number of different filtering members and filtering technologies. In one embodiment, a provided filtration system can include two or more filtering members arranged in series or in parallel, and that are connected in fluid communication with the water-on-water vessels. Some exemplary filtering technologies that are useful in the provided system include reverse osmosis, nanofiltration, ultra filtration and other filtration systems that help remove impurities from the water.

The precision metering devices are used to add a precise amount of concentrate to the mixing portion of the first chamber of each vessel. The concentrate is available to the filtration system from one or more concentrate sources. The concentrate source is a fluid container that contains a premixed solution of various additives to be added to the water in the mixing portion of the first chamber of each vessel when it is in its fill state. The container can be a fixed volume container such as, for example, a tank, vat, or a vessel. Alternatively the container can include a bladder or bag. Typically, concentrate sources contain, for example, formulation additives such as antioxidants, heat-and-light stabilizers, actinic radiation absorbers, dyes, and dispersed pigments, catalysts, medicaments, adjuvant, salts, cosolvents, flavors, vitamins, minerals, disinfectants, deodorizers, antifouling agents, and antiscaling agents. Exemplary minerals and salts that can be added to pure water to formulate a drinkable water product include calcium salts such as calcium chloride, magnesium salts such as magnesium sulfate, sodium bicarbonate, and sodium chloride.

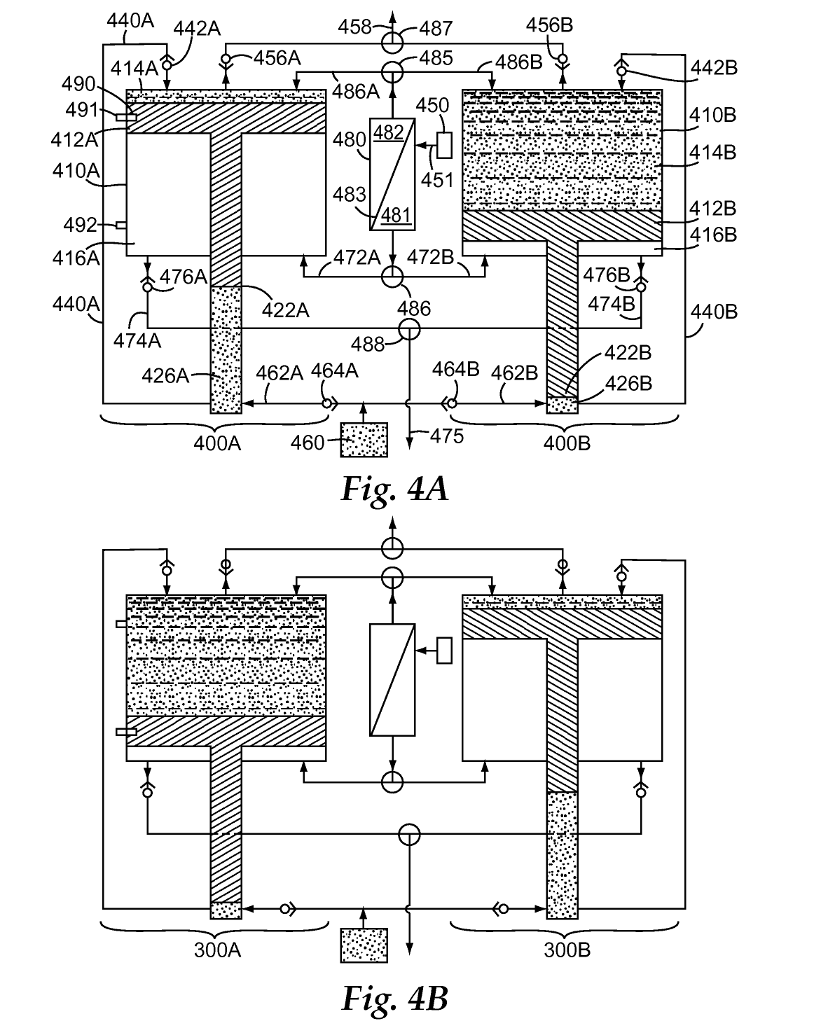

An embodiment of a provided filtration system and method of adding concentrate to a solvent using such a device are illustrated in FIGS. 4A and 4B. FIGS. 4A and 4B each include two water-on-water vessels 400A and 400B. In FIG. 4A, vessel 400A is in a fill state and slave vessel 400B is in a service state. In FIG. 4B, master vessel 400A is in a service state and slave vessel 400B is in a fill state. Both FIGS. 4A and 4B illustrate the same embodiment of a filtration system but are illustrations of the system in two different states.

In the illustrated embodiment of FIGS. 4A and 4B magnet 490 embedded in first piston 412A. Two reed sensors 491 and 492 are incorporated into chamber 410A in such a manner that they can sense when magnet 490 is adjacent to them (e.g., when magnet 490 is sensed by sensor 491, first piston 412A is in its uppermost position as illustrated and when magnet 490 is sensed by reed sensor 492 then first piston 412A is in its bottom most position as illustrated). In FIG. 4A, master vessel 400A has reached the end of its service state and sensor 491 detects magnet 490 and sends a signal to the control system that changes the positions of solenoid valves 485, 486, 487, and 488 which puts the filtration system in condition for continuous output when master vessel 400A is in its fill state. When master vessel 400A reaches the end of its fill state, as illustrated in FIG. 4B, reed sensor 492 senses magnet 490 and signals to the control system to switch solenoid valves 485, 486, 487, and 488 putting the filtration system in condition for continuous output when master vessel 400A is in its service state. Other arrangements of reed sensors and magnets are possible. For example, first piston 412A could have a magnet embedded in its top surface and one reed sensor could be located in the top of the chamber indicating that first piston 412A was at the top of the first chamber.

And second piston 422A could have a magnet embedded in its bottom surface with a reed sensor at the bottom of chamber 426A. So the magnets and reed sensors can be placed in different locations of master vessel 400A. Using a master vessel and a slave vessel simplifies the controls needed for the system since sensors are only necessary on the master vessel. The operation of the filtration system and method of adding concentrate can be described by looking at FIG. 4A. Water source 450 is in fluid communication with water filtration member 480 through water source conduit 451. In the illustrated embodiment, 480 is a reverse osmosis filter member. Reverse osmosis filtration and filter systems are well known to those of ordinary skill in the art of water filtration. Filtration member 480 separates the water into filtered water 482 and waste water 481 through reverse osmosis filter 483. Filtered water 482 flows in the direction of the arrow through solenoid valve 485 which diverts filtered water towards master vessel 400A or slave vessel 400B depending upon a control system (not shown) that coordinates valve positions so as to supply filtered water to the vessel that is in a fill state at any given time. In FIG. 4A, master vessel 400A is in a fill state so filtered water is diverted towards master vessel 400A through filtered water conduit 486A and solenoid valve 485 has shut off flow towards slave vessel 400B through filtered water conduit 486B. A control system controls solenoid valves 485 and 486 so that only one of the first and second vessels is in a service state at any given time.

Solenoid valve 486 works in synchronization with solenoid valve 485 so that when solenoid valve 485 diverts filtered water towards master vessel 400A, solenoid valve 486 diverts waste water towards waste water conduit 472B and into driving portion 416B of slave vessel 400B. Solenoid valve 486 also prevents the flow of waste water through waste water conduit 472A and into master vessel 400A. The force of waste water through waste water conduit 472B and into driving portion 416B of first chamber 410B of slave vessel 400B can be part or all of the force that urges piston 412B upward in the figure as illustrated. Since master vessel 400A is in a fill state, first piston 412A is urged so as to increase the volume of mixing portion 416A of first chamber 410A. In the figure as illustrated, this is in a downward direction. As first piston 412A is urged downward, it urges second piston 426A downward causing concentrate in second chamber 426A to be pushed out of the chamber and into concentrate conduit 440A. One-way checkvalve 464A shuts off backflow to concentrate source 460 and forces the expelled concentrate to flow through conduit 440A, through one-way checkvalve 442A and into mixing portion 414A of first chamber 410A.

Simultaneously, as first piston 412A is urged downward, filtered water flows through filtered water conduit 486A and into mixing portion 414A of first chamber 410A. As first piston 412A is urged downward, water is also forced out of driving portion 416A through one-way checkvalve 476A and solenoid valve 388 which directs the water through drain conduit 474A to drain 375.

At the same time, concentrate has been mixed or diluted with water in mixing chamber 414B during as slave vessel 400B has been in its fill state. Now, slave vessel 400B is switched to its service state. During the service state of slave vessel 400B, waste water is forced through waste water conduit 472B and urges first piston 412B in an upward direction (as illustrated). At the same time one-way checkvalve 476B and solenoid valve 388 prevent waste water from flowing through drain conduit 474B and into drain 375. The force of waste water entering driving portion 416B of first chamber 410B urges first piston 412B upward and the mixture of concentrate and water is forced through one-way checkvalve 456B into product conduit 458. Backflow into master vessel 400A is prevented by one-way checkvalve 456A and solenoid 387. As first piston 412B is urged upward and product is being delivered, second chamber 426B is filling with concentrate from concentrate source 460 and through one-way checkvalve 464B. Alternatively, an external motor can be used to drive the pistons.

FIG. 4B shows the same embodiment illustrated in FIG. 4A except the fill state and the service state of master vessel 400A and slave vessel 400B have been reversed. By utilizing the illustrated two tank system, it is possible to precisely mix concentrate and water and to keep a continuous flow of product through product conduit 458.

It is contemplated that a mixing element in fluid communication with mixing chambers 414A and 414B can be advantageous depending upon the dilution factors and concentrations of additives that are desired. Mixing elements can include air agitation, baffles on the top of the pistons or top of the first chamber, ultrasonics, or other mixing elements well known to those of ordinary skill in the art.

The provided filtration system includes a control system that is configured to control the plurality of valve members. Many types of valve members may be present in the provided filtration systems. For example, the system can utilize solenoid valves as indicated in FIGS. 4A and 4B that can be controlled by the control system and configured to automatically switch between service and fill states when one of the first and second vessels is at a minimum volume (usually substantially empty). Additionally, the filtration system can include other valves, some of which may be passive and don't need control. An example of this type of valve is a one-way checkvalve that may be active (controlled by a control system) or passive (only capable of one-way flow).

Furthermore, filtration systems that have more than two vessels and more than one water filtration member are envisioned as a part of this disclosure. The filtration system can also include a bypass conduit in fluid communication with the water source conduit and the product conduit and configured to bypass the filtration member and the first and second water-on-water vessels.

The provided filtration system and method of adding concentrate to water can be used, for example, to formulate a consistent water product that can be, for example, bottled, dispensed in a food store or a restaurant, sold in a vending machine, or installed in a home or office as a water filtration/formulation unit. Although the size of the unit and the volume of the vessels is unlimited, the provided filtration system and method can be used for small custom uses. For example, if the vessels are between about 200 mL and 10 L, the filtration system can be small and portable.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

1. A filtration system, comprising:
at least one water filtration member;
a first water-on-water vessel in fluid communication with the filtration member and configured to alternate between a service state and a fill state; and
a second water-on-water vessel in fluid communication with the filtration member and configured to alternate between a service state and a fill state;
wherein the first water-on-water vessel, the second water-on-water vessel, or both comprise a device that includes:
a first chamber having a fixed volume and a second chamber having a fixed volume, each chamber having at least one outer wall;
a first piston, disposed in the first chamber so that edges of the first piston slideably contact the outer wall of the first chamber forming a seal that divides the first chamber into a mixing portion and a driving portion; and
a second piston, disposed in the second chamber so that edges of the second piston slideably contact the outer wall of the second chamber forming a seal that defines a concentrate portion concentrate portion in the second chamber,
wherein the first piston and the second piston are in mechanical communication with each other so that when the first piston is displaced in the first chamber, the second piston is displaced in the second chamber, and
wherein, when in the fill state, the concentrate portion of the second chamber is in fluid communication with the mixing portion of the first chamber.

2. A filtration system according to claim 1, wherein the filtration member comprises a reverse osmosis filter.

3. A filtration system according to claim 1, wherein the system further includes a water source in fluid communication with the water filtration member, a waste water conduit in fluid communication with the filtration member and the first and second water-on-water vessels, and a product conduit in fluid communication with the first and second water-on-water vessels.

4. A filtration system according to claim 3, wherein the system further includes a bypass conduit in fluid communication with the water source conduit and the product conduit and configured to bypass the filtration member and the first and second water-on-water vessels.

5. A filtration system according to claim 1, further comprising a plurality of valve members, wherein the valve members comprise at least two solenoid valves and at least one one-way checkvalve.

6. A filtration system according to claim 1, further comprising a control system, wherein the control system controls the at least two solenoid valves so that only one of the first and second vessels is in a service state at any given time.

7. A filtration system according to claim 1, further comprising a control system, wherein the control system controls the at least two valve members to automatically switch between service and fill states for the first and second vessels when one of the first and second vessels is in an empty state.

8. A filtration system according to claim 1, wherein the concentrate portion of the second chamber is in fluid communication with one or more concentrate sources.

9. A filtration system according to claim 1, further comprising a control system, wherein the control system comprises a set of sensors on only one vessel.

10. A filtration system according to claim 9, wherein one or more concentrate sources are contained in a bladder.

11. A filtration system according to claim 1, wherein the filtration member comprises a reverse osmosis filter and the concentrate source includes at least one salt selected from the group consisting of calcium chloride, magnesium sulfate, sodium bicarbonate and sodium chloride.

12. A water dispensing system comprising a filtration system according to claim 1.

13. A method of delivering filtered water with a water filtration system, the water filtration system including at least one filtering member, first and second water-on-water storage vessels, at least one concentrate source, and a control system, the first and second storage vessels each being configured to alternate between a fill state wherein the storage vessel is filled with filtered water and a service state wherein filtered water is expelled from the storage vessel, the method comprising:
generating a supply of filtered water with the filtering member;
adding concentrate from at least one concentrate source to the first storage vessel using a dosing device; and
adding concentrate from at least one concentrate source to the second storage vessel using a precision metering device;
wherein the precision metering device includes:
a first chamber having a fixed volume and a second chamber having a fixed volume, each chamber having at least one outer wall;
a first piston, disposed in the first chamber so that edges of the first piston slideably contact the outer wall of the first chamber forming a seal that divides the first chamber into a mixing portion and a driving portion; and
a second piston, disposed in the second chamber so that edges of the second piston slideably contact the outer wall of the second chamber forming a seal that defines a concentrate portion concentrate portion in the second chamber,
wherein the first piston and the second piston are in mechanical communication with each other so that when the first piston is displaced in the first chamber, the second piston is displaced in the second chamber, and
wherein the concentrate portion of the second chamber is in fluid communication with the mixing portion of the first chamber.

14. A method of delivering filtered water with a water filtration system according to claim 13, further comprising controlling a plurality of valves with a control system to set the first storage vessel in a fill state and the second storage vessel in a service state.

15. A method of delivering filtered water with a water filtration system according to claim 14, further comprising controlling the plurality of valves with the control system to set the first storage vessel in a service state and the second storage vessel in a fill state.

16. A method of delivering filtered water with a water filtration system according to claim 13, wherein the system further includes a water source in fluid communication with the water filtration member, a waste water conduit in fluid communication with the filtration member and the first and second water-on-water vessels, and a product conduit in fluid communication with the first and second water-on-water vessels.

17. A method of delivering filtered water with a water filtration system according to claim 13, wherein the system further includes a bypass conduit in fluid communication with the water source conduit and the product conduit and configured to bypass the filtration member and the first and second water-on-water vessels.

18. A method of delivering filtered water with a water filtration system according to claim 14, wherein the valve members comprise at least two solenoid valves and at least one one-way checkvalve.

19. A method of delivering filtered water with a water filtration system according to claim 14, wherein the control system controls the at least two solenoid valves so that only one of the first and second vessels is in a service state at any given time.

20. A method of delivering filtered water with a water filtration system according to claim 14, wherein the control system controls the at least two valve members to automatically switch between service and fill states for the first and second vessels when one of the first and second vessels is in an empty state.

21. A method of delivering filtered water with a water filtration system according to claim 13, wherein the concentrate portion of the second chamber is in fluid communication with one or more concentrate sources.

22. A method of delivering filtered water with a water filtration system according to claim 21, wherein the one or more concentrate sources are contained in a bladder.
